(19) United States
(12) Patent Application Publication
(10) Pub. No.: US 2020/0038762 A1
(43) Pub. Date: Feb. 6, 2020

(54) Methods, Systems and Apparatus for Global Work-driven Gaming

(71) Applicant: James P. Janniello, Sarasota, FL (US)

(72) Inventor: James P. Janniello, Sarasota, FL (US)

(21) Appl. No.: 16/541,138

(22) Filed: Aug. 14, 2019

Related U.S. Application Data
(63) Continuation-in-part of application No. 14/535,123, filed on Nov. 6, 2014.

(51) Int. Cl. A63F 13/80; A63F 13/792; G06F 17/18

(52) U.S. Cl. CPC A63F 13/80; G06F 17/18; A63F 13/792

(57) ABSTRACT

Methods, systems, and apparatus for performing a work-driven game are described. An indication of a completion of a performance of a work event is obtained from a work processing system associated with a user and a value of the work event is normalized. A gaming asset associated with the game in a game processing system is awarded in response to the indication of the completion of the performance of the work event from the work processing system, the gaming asset awarded based on the normalized value.

### CLAIM OF PRIORITY

This application claims the benefit of priority under 35 U.S.C. § 119(e) of U.S. Provisional Patent Application Ser. No. 61/900,643, filed on Nov. 6, 2013, U.S. patent application Ser. No. 14/535,123, filed on Nov. 6, 2014, and U.S. Provisional Patent Application Ser. No. 62/764,730, filed on Aug. 15, 2018 which are incorporated by reference herein in their entirety.

### TECHNICAL FIELD

The present application relates generally to electronic gaming, and more specifically, in one example, to driving gaming activity based on work events, including work tasks, work results, and work status.

### BACKGROUND

Electronic gaming often involves players who control certain gaming activities and a gaming processor that controls other gaming activities. The gaming processor may manage the state of the game, the state of active players and, optionally, the state of inactive players. The various states may be used to determine a game event(s) and/or new states of the player(s) and the game. A player's gaming activity may be measured based on skill, dexterity, knowledge, and the like.

Electronic gaming is often driven by inputs received from a game player. For example, a joystick, an electronic mouse, a camera, a microphone, a controller, and the like may be used to gather input information from a player. The input information may be visual information, motion information, audio information, speech information, text information, and the like. Based on the input generated by the player, the player may be awarded a gaming asset, may initiate a gaming action, and/or may achieve a gaming objective.

### BRIEF DESCRIPTION OF THE DRAWINGS

Some embodiments are illustrated by way of example and not limitation in the figures of the accompanying drawings in which:

FIG. 1 is a block diagram of an example system, in accordance with an example embodiment, for performing work-driven gaming;

FIG. 2 is a block diagram of an example apparatus, in accordance with an example embodiment, for performing work-driven gaming;

FIG. 3A is a representation of an example rule base comprising one or more rules for determining a gaming event for a work-driven gaming environment, in accordance with an example embodiment;

FIG. 3B is a representation of an example class table comprising one or more classes of awards for a work-driven gaming environment, in accordance with an example embodiment;

FIG. 3C is a representation of an example table illustrating a mapping of an award to gaming input for a work-driven gaming environment, in accordance with an example embodiment;

FIG. 4 is a flowchart for an example work-driven gaming method, in accordance with an example embodiment;

FIG. 5 is a flowchart for an example work interface method, in accordance with an example embodiment;

FIG. 6 is a representation of an example user interface for performing a phrase guessing game, in accordance with an example embodiment;

FIG. 7 is a flowchart for an example gaming method, in accordance with an example embodiment;

FIG. 8 is a flowchart for an example user interface method for performing a phrase guessing game, in accordance with an example embodiment; and

FIG. 9 is a block diagram of machine within which instructions may be executed for causing the machine to perform any one or more of the methodologies discussed herein.

### DETAILED DESCRIPTION

In the following detailed description of example embodiments, reference is made to specific examples by way of drawings and illustrations. These examples are described in sufficient detail to enable those skilled in the art to practice these example embodiments, and serve to illustrate how the invention may be applied to various purposes or embodiments. Other embodiments of the invention exist and are within the scope of the invention, and logical, mechanical, electrical, and other changes may be made without departing from the scope or extent of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

Generally, methods, systems, and apparatus for performing work-driven gaming are described. In one example embodiment, a work event, such as a work result, a completion of a work task, a change in status of a work item, and the like results in the awarding of a gaming asset to a worker or a team of workers. As used herein, a “gaming asset” includes, but is not limited to, a virtual asset, a clue, an action within a gaming environment, an input to a gaming environment, an advancement to another level in a game, an action of an avatar, and the like. The gaming asset, such as the advancement to another level in a game, may be obtained, for example, by generating gaming input to the gaming environment on behalf of the player. In one example embodiment, the gaming input generated on behalf of the player is submitted, for example, to a conventional electronic game. For example, the gaming input may be submitted via an interface conventionally used for interfacing to a keyboard, a mouse, a joystick, a camera, a controller, and the like. Each game may be designed for players who are employees or other workers in order to drive employee engagement, motivation, and communication among players. Each gaming solution provides employees with a gaming environment driven, in part, by their work accomplishments.

As used herein, a work event is a work result, a completion of a work task, a change in status of a work item, a meeting or an exceeding of one or more of a sales goal, a work safety goal, a quality goal, a customer satisfaction goal, an external recognition goal, a production goal, and the like.

Games that may be work-driven include games of skill, games of chance, games of intellect, and the like. As used herein, a “work-driven” game is a game that is driven partially or completely based on work events.

In one example embodiment, a phrase guessing game is work-driven. A player is presented with the structure of a phrase or sentence, as described more fully below, and the user may attempt to guess the correct phrase. A goal of the game is to correctly guess the phrase in the shortest amount of time. The user is awarded, for example, one or more letters of the phrase in response to a work event.

In one example embodiment, a conventional phrase guessing game is transformed into a work-driven game. A work-driven gaming apparatus inputs one or more correct letters into the conventional phrase guessing game on behalf of the player in response to a work event. For example, the completion of a work task may result in the entry of two letters in the phrase guessing game by the work-driven gaming apparatus via a keyboard interface of a conventional phrase guessing game.

In one example embodiment, a mountain climbing game is work-driven. The goal is for the user to reach the summit of a mountain in the shortest amount of time. The player is awarded a certain level, such as reaching a base camp, or is awarded an action, such as an avatar jumping to a higher ledge on the mountain, in response to a work event.

In one example embodiment, a multi-player game is work-driven where a plurality of users (players) compete against each other in a game or other type of competition. Gaming assets are distributed to each player based on each player's work events. In one example embodiment, work events performed by a first user result in the awarding of a gaming asset to another user, such as the employment manager of the first user. Moreover, members of a team of users (or a subset of the members of the team of users) may be awarded gaming assets based on the work events performed by one or more members of the team or one or more other users. In competitions where users are assigned different types of work events to perform, the value of the work events are normalized, as described more fully below, in order to “level the playing field” of users performing work events with different requirements, in different work areas, in different professions, and the like.

Each award is characterized by its particular value to the game. In one example embodiment, awards are categorized into classes based on their value, where each class contains awards corresponding to a particular value range. For example, each class may be labeled by a letter, such as “A”, “B”, “C”, and the like, where each letter corresponds to a particular value range. In one example embodiment, an award for a particular work event is selected from an award class that is commensurate with the value of the work event.

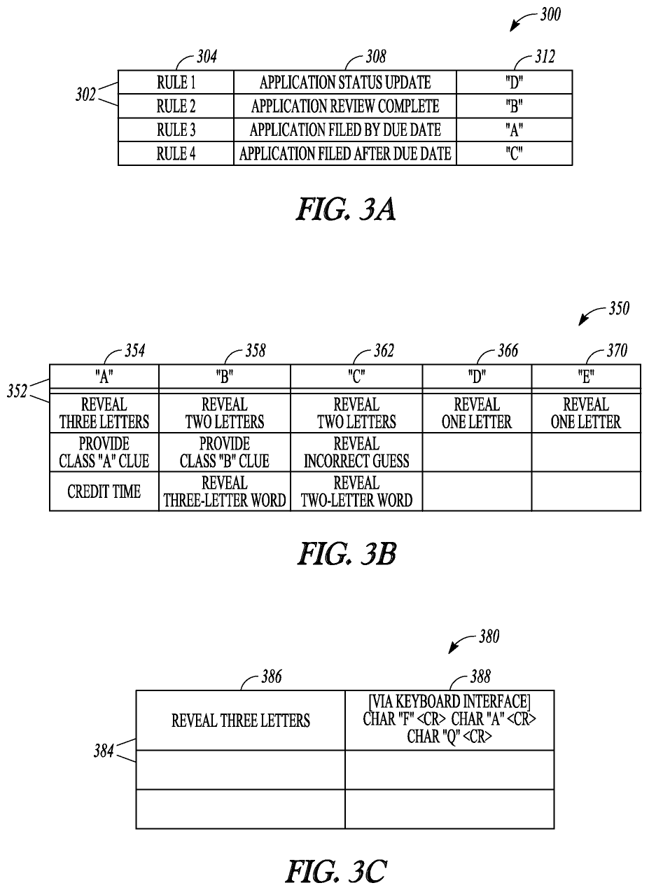

In one example embodiment, different types of work events are normalized in terms of value in order to fairly award assets based on the difficulty of the work event, the time required to complete the work event, the level of results achieved, the probability of successfully completing the work event, and the like. These criteria, such as the time required to perform the work event and the probability of success, are used to normalize the awards that are granted based on the normalized value of the event. For example, successful completion of a work event that is normally successful 65% of the time would result in a more valuable asset being awarded than a work event that is normally successful 95% of the time. In one case, the value of the asset is inversely proportional to the probability of successfully completing the work event. Successful completion of a work event that requires three hours of work would result, for example, in a more valuable asset being awarded than a work event that is completed in one hour. In one case, the value of the asset is proportional to the time required for completing the work event. Successful completion of a work event that required 60% of the normal time to complete the work event would result, for example, in a more valuable asset being awarded than a work event that required 90% of the normal time to complete the work event. In one case, the value of the asset is inversely proportional to the time required to complete the work event in relation to the normal time required for completing the work event. Successful completion of a work event that has an equivalent cash value of $10,000, for example, would result in a more valuable asset being awarded than a work event that has an equivalent cash value of $3,000. In one case, the value of the asset is proportional to the cash value. Successful completion of a work event ahead of schedule would, for example, result in a more valuable asset being awarded than a work event that is completed late. A gaming administrator may define the conditions that constitute the work event as well as the assets that are awarded for completing each class or type of work event. For example, a rule base may be used to define the conditions that constitute the work event as well as the assets that are awarded for completing each class or type of work event, as described more fully below in conjunction with FIG. 3A.

As described above, successfully completed work events generate gaming assets within the gaming environment. In one example embodiment, an accumulation of one or more gaming assets is necessary to start and/or continue game play. Thus, game play can be automatically regulated by a user's work productivity.

In one example embodiment, game play is disabled when a particular type of gaming asset is not in the user's inventory of assets, when a particular quantity of one or more types of gaming assets is not in the user's inventory of assets, during the performance of selected work events, and the like. For example, game play may be suspended during the performance of a critical work event, during the performance of a work event that requires a high degree of concentration, and the like. In one example embodiment, to disable game play, the user interface for the game is hidden from the user, or the user interface is exposed to the user but with a set of gaming functions being inaccessible or otherwise disabled. Similarly, the gaming user interface may be disabled or hidden during certain times of day or during the performance of selected work events.

In one example embodiment, access to a gaming user interface is enabled and disabled by the status of a work event(s). For example, a user interface may be provided to a user when a particular work event is started or completed, and may be disabled upon the start or completion of another work event or the same work event. In one example embodiment, a work task that comprises a plurality of work events is used to award gaming assets, enable game play, and the like. For example, a work task may comprise a set of work events and a gaming asset may be awarded when a particular set or subset of the work events that comprise the work task is completed.

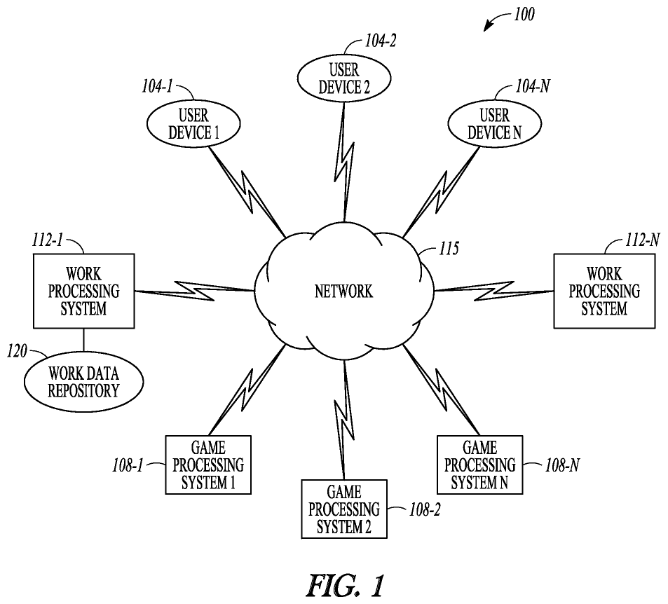

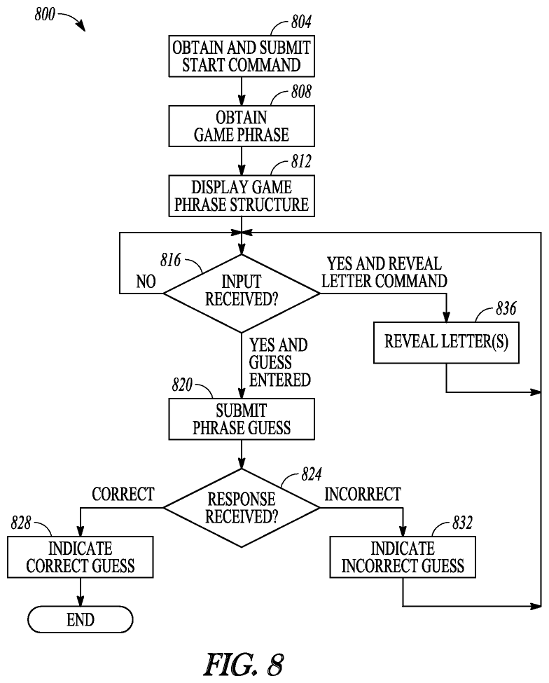

FIG. 1 is a block diagram of an example system 100 for performing work-driven gaming, in accordance with an example embodiment. In one example embodiment, the system 100 comprises one or more user devices 104-1, 104-2 and 104-N (known as user devices 104 hereinafter), one or more work processing systems 112-1 through 112-N (known as work processing systems 112 hereinafter), one or more game processing systems 108-1, 108-2 and 108-N (known as game processing systems 108 hereinafter), and a network 115. Each user device (e.g., 104-1) may be a personal computer (PC), a tablet computer, a mobile phone, a personal digital assistant (PDA), a wearable computing device (e.g., a smartwatch), or any other appropriate computer device. Each user device (104-1, 104-2 or 104-N) may include a user interface processing module for providing a user interface, described more fully below in conjunction with FIGS. 6 and 8. In one example embodiment, the user interface processing module may comprise a web browser program. Although a detailed description is only illustrated for user device 104-1, it is noted that each of the other user devices (e.g., user device 104-2 through user device 104-N) may have corresponding elements with the same functionality.

The work processing systems 112 collaborate with a user or group of users in performing work related tasks. For example, the work processing system 112-1 may be a legal docketing application for managing legal cases. The legal docketing application may maintain a status for each legal case including, for example, pending work items, due dates for work items, and a status for each work item.

The game processing systems 108 are informed of and/or detect a work event, such as an update to a status of a work item, a change in a status of a work item, a milestone for a work item, and the like. In response to being informed of a work event, the game processing system 108, for example, awards a gaming asset to the user or group of users associated with the work event.

The network 115 may be a local area network (LAN), a wireless network, a metropolitan area network (MAN), a wide area network (WAN), a wireless network, a network of interconnected networks, the public switched telephone network (PSTN), and the like.

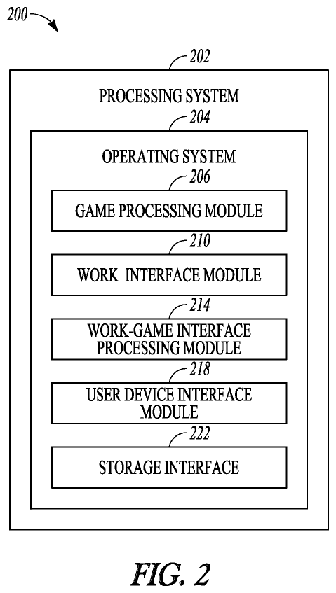

FIG. 2 is a block diagram of an example apparatus 200, in accordance with an example embodiment, for performing work-driven gaming. The apparatus 200 is shown to include a processing system 202 that may be implemented on a client or other processing device that includes an operating system 204 for executing software instructions.

In accordance with an example embodiment, the apparatus 200 includes a game processing module 206, a work interface module 210, a work-game interface processing module 214, and a user device interface module 218. In accordance with an example embodiment, the apparatus 200 may further include a storage interface 222.

The work interface module 210 provides information on work events to, for example, the work-game interface processing module 214. The work interface module 210 obtains the work events from a wide variety of conventional work-based systems and databases, including inventory applications, sales management systems, manufacturing systems, web-based applications, and the like.

The user device interface module 218 obtains work events logged by a user or administrator, and obtains work events detected by the user device 104 while a user conducts conventional work activities. For example, the user device 104 may detect the completion of a sale by a salesperson, and the corresponding work event detected by the user device 104 may be transferred to the user device interface module 218. The user device interface module 218 provides information on work events to game processing module 206 and/or to work-game interface processing module 214.

The work-game interface processing module 214 obtains work event information from the work interface module 210 and/or the user device interface module 218, and generates gaming input for the game processing module 206 based on the obtained work event information. In one example embodiment, the work-game interface processing module 214 generates the gaming input by mapping and/or translating a work event to gaming input. As described more fully above, the gaming input may be input signals that emulate an input device, such as a keyboard, a mouse, a joystick, a camera, a controller, and the like, and may be generated for a conventional gaming environment on behalf of the player. In one example embodiment, the gaming input is transferred to the conventional gaming environment via one or more interfaces on the conventional gaming environment. Interfaces include, but are not limited to, a keyboard interface, a mouse interface, a joystick interface, a camera interface, a controller interface, and the like.

The game processing module 206 obtains gaming input from the work-game interface processing module 214 and/or the user device interface module 218, and generates a gaming environment for a user or team of users.

In one example embodiment, the game processing module 206 generates gaming input for a conventional gaming environment on behalf of a player. For example, the game processing module 206 may enter one or more letters of a phrase guessing game into a conventional phrase guessing game on behalf of the user. The gaming input may be submitted to the conventional phrase guessing game via a custom interface or via an existing interface on the conventional game.

In one example embodiment, the game processing module 206 is preconfigured with the appropriate input for a conventional game. In one example embodiment, the game processing module 206 learns the appropriate input called for by a conventional game by tracking earlier game playing sessions. For example, the gaming processing module 206 may track the input to and output from the conventional game to learn the structure of the input and/or the output used by the conventional game. In one example embodiment, the game processing module 206 maps a work event or a gaming asset to the appropriate structure for gaming input for a conventional game.

In one example embodiment, the game processing module 206 normalizes the value of a work event and determines an asset to award based on the normalized value, as described herein. For example, as described below in conjunction with FIG. 3A, a rule may specify a table or formula for normalizing the value of a work event based on the type or class of work event and for determining the class of asset to be awarded for the normalized work event.

FIG. 3A is a representation of an example rule base 300 comprising one or more rules that are statically or dynamically used to determine a class of an award for a work-driven gaming environment, in accordance with an example embodiment. Each row 302 of the rule base 300 corresponds to one rule. Column 304 comprises a rule identifier, column 308 comprises the condition for applying the corresponding rule, and column 312 comprises a class for an award. Example conditions are based on one or more of: 1) an occurrence of a work event; 2) a status of a work item; 3) a change in status of a work item; 4) a milestone for a work item; 5) a meeting or an exceeding of one or more of a sales goal, a work safety goal, a quality goal, a customer satisfaction goal, an external recognition goal, a production goal; 6) a type or class of work event, and the like. Example awards may comprise a gaming asset, such as a virtual asset, a clue, an action within a gaming environment, an input to a gaming environment, an advancement to another level in a game, an action of an avatar, and the like. For example, a rule of the rule base 300 indicates that the value of the asset is inversely proportional to the probability of successfully completing the work event (as indicated by a history of previously completed tasks), where a class A asset is awarded for a successfully completed work event that has a 1-25% probability of success, a class B asset is awarded for a successfully completed work event that has a 26-50% probability of success, a class C asset is awarded for a successfully completed work event that has a 51-75% probability of success, and a class D asset is awarded for a successfully completed work event that has a 76-100% probability of success.

A rule of the rule base 300 may indicate that the value of the asset is inversely proportional to the time required to complete the work event in relation to the normal time required for completing the work event, where a class A asset is awarded for a successfully completed work event that is completed within 1-25% of the average time to successfully complete the work event, a class B asset is awarded for a successfully completed work event that is completed within 25-75% of the average time to successfully complete the work event, a class C asset is awarded for a successfully completed work event that is completed within 76-125% of the average time to successfully complete the work event, and a class D asset is awarded for a successfully completed work event that is completed within 126-200% of the average time to successfully complete the work event. In this example, no asset is awarded for a work event that required more than 200% of the average time to successfully complete.

A rule of the rule base 300 indicates that the value of the asset is proportional to the cash value of the work event, where a class A asset is awarded for a successfully completed work event that has a value greater than $10,000, a class B asset is awarded for a successfully completed work event that has a value of between $5,000 and $9,999, a class C asset is awarded for a successfully completed work event that has a value between $2,500 and $4,999, and a class D asset is awarded for a successfully completed work event that has a value less than $2,500.

FIG. 3B is a representation of an example class table 350 comprising one or more classes for awards for a work-driven gaming environment, in accordance with an example embodiment. Each column 354, 358, 362, 366, 370 of the class table 350 corresponds to a class of award. Column 354 comprises one or more class “A” awards, column 358 comprises one or more class “B” awards, column 362 may comprise one or more class “C” awards, column 366 comprises one or more class “D” awards, and column 370 comprises one or more class “E” awards.

FIG. 3C is a representation of an example table 380 illustrating a mapping of an award to gaming input for a work-driven gaming environment, in accordance with an example embodiment. Each row 384 corresponds to an award. Column 386 comprises an identifier of the corresponding award and column 388 comprises one or more gaming inputs for granting the award.

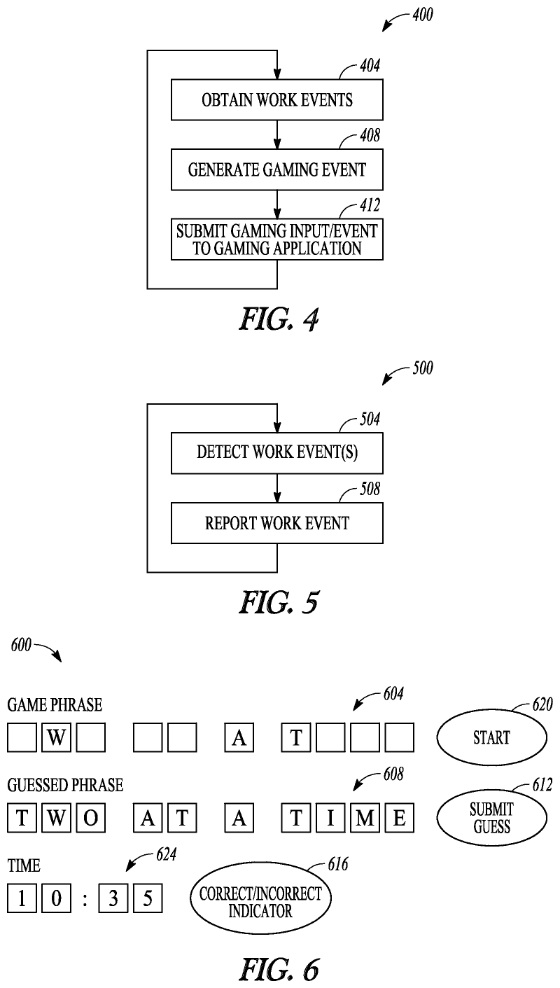

FIG. 4 is a flowchart for an example work-driven gaming method 400, in accordance with an example embodiment. In one example embodiment, the work-driven gaming method 400 is performed by the work-game interface processing module 214.

One or more work events are obtained (operation 404). The work event may be obtained, for example, from the user device interface module 218 and/or the work interface module 210. For example, a user may update a status of a pending case in a legal docketing application via the user device 104-1. The user device 104-1 may submit a work event to the work-game interface processing module 214 based on the status update. The work event may be submitted to the work-game interface processing module 214 at the request of the user or automatically by the user device 104-1.

In one example embodiment, a salesperson meets a sales goal and a work event is submitted to the work-game interface processing module 214. The work event may be submitted by the work interface module 210 and may be submitted at the request of a user. In one example embodiment, the work event is detected by the work interface module 210 and automatically submitted by the work interface module 210.

For each obtained work event, a gaming event is generated (operation 408). The gaming event is the awarding of a gaming asset and/or the generation of gaming input. In one example embodiment, a work event may be translated into a gaming award. For example, a formula may be used to determine a gaming award based on an amount of sales by a salesperson for a specific time period, such as a day, week and/or month. In one example embodiment, the class of an award is proportional to an amount of sales by a salesperson.

In one example embodiment, a rule base is used to determine the class of the gaming award. For example, a rule may indicate that a class “B” gaming asset is to be awarded to each member of a sales team that meets or exceeds a monthly goal. In another example, a user may be awarded a class “C” asset for updating a status of a pending legal case by a prescribed deadline.

A generated gaming event and/or gaming input is submitted to a gaming application (operation 412) and the method proceeds to operation 404. For example, a gaming input indicating that an award should be presented to a user may be submitted to the game processing module 206. In one example embodiment, gaming input is submitted to a conventional gaming environment via the game processing module 206. For example, a gaming input indicating that an award should be presented to a user may be submitted to a conventional gaming environment.

In one example embodiment, the gaming input is generated by mapping and/or translating a work event to a gaming event. In one example embodiment, the mapping is based on the rule base described more fully above in conjunction with FIG. 3A.

FIG. 5 is a flowchart for an example work interface method 500, in accordance with an example embodiment. In one example embodiment, the work interface method 500 is performed by the work interface module 210.

One or more work events are detected (operation 504). The work event may be detected, for example, by monitoring various systems, applications, and communications among systems and users. For example, electronic mail may be monitored to identify a project milestone. An inventory database may be monitored to detect an achievement of a productivity goal. A legal docketing application may be monitored to detect the updating of a status of a case or a filing of a legal brief.

The detected work event(s) is reported to a gaming application (operation 508). For example, the detected work event(s) may be reported to the work-driven gaming method 400.

FIG. 6 is an example representation of a user interface 600 for performing a phrase guessing game, in accordance with an example embodiment. A mobile device may provide the user interface 600, for example. A game is started by selecting the “start” radio button 620. A structure of a phrase to be guessed is displayed in phrase display area 604. The structure indicates the number of words in the phrase and the number of letters in each word. As letters are revealed, the block representing the corresponding letter is replaced with the corresponding letter.

A user may enter a guess of the phrase in phrase input field 608. Once a phrase has been entered in the phrase input field 608, the user may select the “submit guess” radio button 612 to submit the phrase guess. A “correct or incorrect” guess indicator 616 indicates whether the guess is correct or incorrect.

During a game, a timer field 624 indicates the amount of elapsed time since the start of the game. Once the phrase has been correctly guessed, the timer field 624 indicates the amount of time used to complete the game.

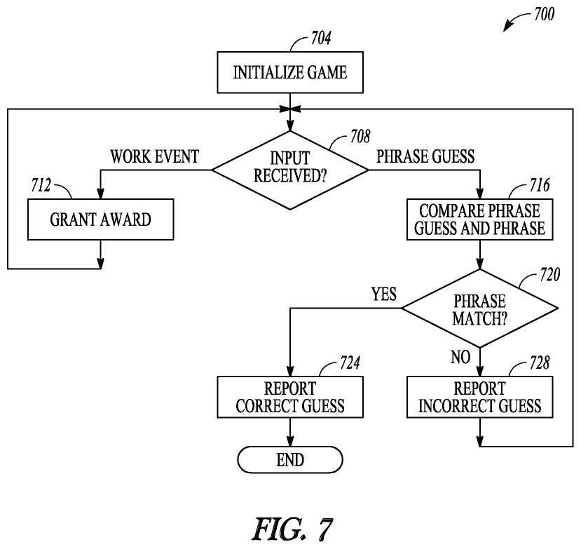

FIG. 7 is a flowchart for an example gaming method 700, in accordance with an example embodiment. In one example embodiment, the gaming method 700 is performed by the game processing module 206. In one example embodiment, a phrase guessing game is executed, as described more fully below.

A phrase guessing game is initialized (operation 704). For example, a phrase may be selected from a phrase database, a timer may be started, and the structure of the phrase (such as the number of words and letters per word in the phrase) may be presented to a user. A test is performed to determine if a gaming input has been received from the work interface module 210 or if a phrase guess has been entered by a user (operation 708). If a work event has been received from the work interface module 210, the work event is translated to an award class, and an award from the award class is selected. For example, one or more letters of the phrase may be revealed (operation 712). For example, if a work event is received indicating that a class “A” asset be awarded, one or more letters of the phrase that correspond to a class “A” asset may be revealed and the method 700 may proceed with operation 708.

If a phrase guess has been entered by a user, the phrase guess is compared to the actual phrase (operation 716). A test is performed to determine if the phrase guess matches the actual phrase (operation 720). If the actual phrase matches the phrase guess, the user is informed of the match, the timer is stopped and the time used to complete the game is displayed to the user (operation 724). The method 700 then ends. If the actual phrase does not match the phrase guess, the user is informed of the mismatch (operation 728) and the method 700 proceeds to operation 708.

FIG. 8 is a flowchart for an example user interface method 800 for performing a phrase guessing game, in accordance with an example embodiment. In one example embodiment, one or more of the operations of the user interface method 800 are performed by the user device 104-1.

A user initiates a phrase guessing game by selecting the “start” radio button 620. In response to the user selecting the “start” radio button 620, a start command is submitted to, for example, the user device interface module 218 (operation 804). A phrase is obtained, for example, from the user device interface module 218 (operation 808). The structure of the phrase is displayed in phrase display area 604 (operation 812). A test is performed to determine if a guess has been submitted by the user or if one or more letters of the phrase may be revealed (operation 816).

If a user has submitted a guess, the phrase entered in the phrase input field 608 is submitted to the user device interface module 218 (operation 820). A test is performed to determine if a response to the guess has been received (operation 824). If a response to the guess has been received and the result indicates a correct guess, the result is indicated in the guess indicator 616 and the timer is stopped (operation 828). The method 800 then ends.

If a response to the guess has been received and the result indicates an incorrect guess, the result is indicated in the guess indicator 616 (operation 832) and the method 800 proceeds to operation 816.

If one or more letters of the phrase are to be revealed, the block(s) corresponding to the letter(s) to be revealed are replaced with the corresponding letter (operation 836). The method 800 then proceeds with operation 816.

Although certain examples are shown and described here, other variations exist and are within the scope of the invention. It will be appreciated by those of ordinary skill in the art that any arrangement, which is designed or arranged to achieve the same purpose, may be substituted for the specific embodiments shown. This application is intended to cover any adaptations or variations of the example embodiments of the invention described herein. It is intended that this invention be limited only by the claims, and the full scope of equivalents thereof.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network 115 (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

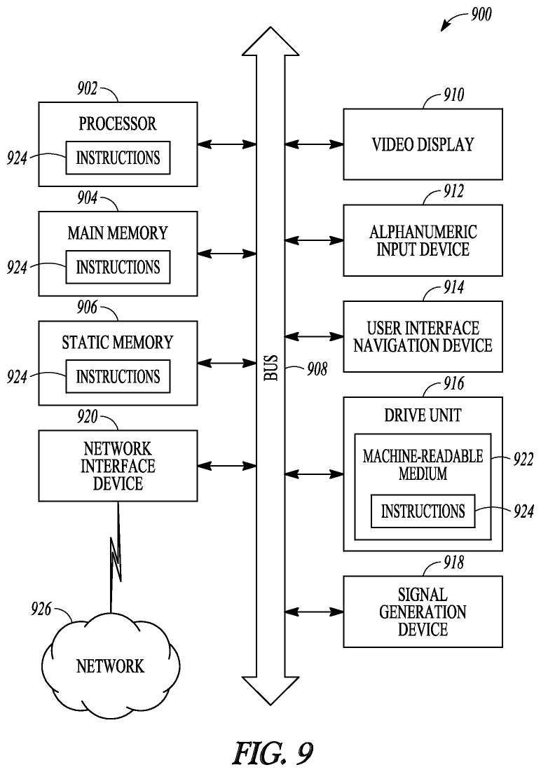

FIG. 9 is a block diagram of a machine within which instructions may be executed for causing the machine to perform any one or more of the methodologies discussed herein. In one example embodiment, the machine may be the user device 104. In one example embodiment, the machine may be the work-driven gaming apparatus 200. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation device 914 (e.g., a mouse), a disk drive unit 916, a signal generation device 918 (e.g., a speaker) and a network interface device 920.

### Machine-Readable Medium

The drive unit 916 includes a machine-readable medium 922 on which is stored one or more sets of instructions 924 and data structures (e.g., software) embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media. Instructions 924 may also reside within the static memory 906.

While the machine-readable medium 922 is shown in an example embodiment to be a single medium, the term “machine-readable medium” may include a single medium or multiple media (e.g., a centralized or distributed database, and/or associated caches and servers) that store the one or more instructions 924 or data structures. The term “machine-readable medium” shall also be taken to include any tangible medium that is capable of storing, encoding or carrying instructions 924 for execution by the machine and that cause the machine to perform any one or more of the methodologies of the present invention, or that is capable of storing, encoding or carrying data structures utilized by or associated with such instructions 924. The term “machine-readable medium” shall accordingly be taken to include, but not be limited to, solid-state memories, and optical and magnetic media. Specific examples of machine-readable media 922 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions 924 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A work-game interface processing module for performing a work-driven game, the work-game interface processing module comprising:
a processor; and
memory to store instructions that, when executed by the processor, cause the processor to perform operations comprising:
obtaining an indication of a completion of a performance of a work event from a work processing system associated with a user;
normalizing a value of the work event; and
awarding a gaming asset associated with the game in a game processing system in response to the indication of the completion of the performance of the work event from the work processing system, the gaming asset awarded based on the normalized value.

2. The apparatus of claim 1, wherein the normalized value of the work event is inversely proportional to a probability of successfully completing the work event.

3. The apparatus of claim 1, wherein the normalized value of the work event is inversely proportional to an amount of time required for completing the work event.

4. The apparatus of claim 1, wherein the normalized value of the work event is inversely proportional to an amount of time required for completing the work event in relation to an average time required for completing the work event.

5. The apparatus of claim 1, wherein the normalized value of the work event is proportional to a cash value of the work event.

6. The apparatus of claim 1, wherein the gaming asset advances a state of a user during the game toward achieving a gaming objective based on the normalized value.

7. The apparatus of claim 1, the operations further comprising selecting a class of the gaming asset based on the normalized value.

8. The apparatus of claim 1, the operations further comprising mapping the gaming asset to gaming input, the gaming asset being based on the normalized value.

9. The apparatus of claim 8, the operations further comprising submitting the gaming input to a gaming environment.

10. The apparatus of claim 1, the operations further comprising updating the work-driven game based on the gaming asset and the normalized value.

11. A method for performing a work-driven game, the method comprising:
obtaining an indication of a completion of a performance of a work event from a work processing system associated with a user;
normalizing a value of the work event; and
awarding a gaming asset associated with the game in a game processing system in response to the indication of the completion of the performance of the work event from the work processing system, the gaming asset awarded based on the normalized value.

12. The method of claim 11, wherein the normalized value of the work event is inversely proportional to a probability of successfully completing the work event.

13. The method of claim 11, wherein the normalized value of the work event is inversely proportional to an amount of time required for completing the work event.

14. The method of claim 11, wherein the normalized value of the work event is inversely proportional to an amount of time required for completing the work event in relation to an average time required for completing the work event.

15. The method of claim 11, wherein the normalized value of the work event is proportional to a cash value of the work event.

16. The method of claim 11, wherein the gaming asset advances a state of a user during the game toward achieving a gaming objective based on the normalized value.

17. The method of claim 11, further comprising selecting a class of the gaming asset based on the normalized value.

18. The method of claim 11, further comprising mapping the gaming asset to gaming input, the gaming asset being based on the normalized value.

19. The method of claim 11, comprising updating the work-driven game based on the gaming asset and the normalized value.

20. A non-transitory computer readable medium comprising computer executable instructions which when executed by a computer cause the computer to perform operations comprising:
obtaining an indication of a completion of a performance of a work event from a work processing system associated with a user;
normalizing a value of the work event; and
awarding a gaming asset associated with the game in a game processing system in response to the indication of the completion of the performance of the work event from the work processing system, the gaming asset awarded based on the normalized value.
